(19) United States
(12) Patent Application Publication
(10) Pub. No.: US 2020/0302382 A1
(43) Pub. Date: Sep. 24, 2020

(54) LOGISTICS METHOD AND SYSTEM, AIRCRAFT, DELIVERY ROBOT, DISPATCH PLATFORM, AND HANDOVER METHOD

(71) Applicants: BEIJING JINGDONG SHANGKE INFORMATION TECHNOLOGY CO., LTD., Beijing (CN); BEIJING JINGDONG CENTURY TRADING CO., LTD., Beijing (CN)

(72) Inventors: Weiwei GU, Beijing (CN); Jun XIAO, Beijing (CN); Jinhua CAI, Beijing (CN); Yanguang LIU, Beijing (CN); Chen FAN, Beijing (CN)

(73) Assignees: BEIJING JINGDONG SHANGKE INFORMATION TECHNOLOGY CO., LTD., Beijing (CN); BEIJING JINGDONG CENTURY TRADING CO., LTD., Beijing (CN)

(21) Appl. No.: 16/651,388

(22) PCT Filed: Jul. 10, 2018
(86) PCT No.: PCT/CN2018/095190

§ 371 Date: Mar. 27, 2020

(30) Foreign Application Priority Data
Sep. 30, 2017 (CN) 201710912824.X

(51) Int. Cl. G06Q 10/08; G08G 5/00; B64D 9/00

(52) U.S. Cl. CPC G06Q 10/0832; B64D 9/00; G08G 5/003; G06Q 10/08355

(57) ABSTRACT

The present disclosure discloses a logistics method and system, an aircraft, a distribution robot, a dispatching platform and a handover method. The method includes: transporting, by an aircraft, cargoes from a distribution station to a cargo handover location of the aircraft and a distribution robot according to a fixed route; delivering, by the aircraft, the cargoes to the distribution robot; distributing, by the distribution robot, the cargoes to a distribution address.

### CROSS-REFERENCE TO RELATED APPLICATIONS

The present disclosure is based on and claims priority of Chinese application for invention 201710912824.X, filed on Sep. 30, 2017, the disclosure of which is hereby incorporated into this disclosure by reference in its entirety.

### TECHNICAL FIELD

The present disclosure relates to the field of logistics, and in particular, to a logistics method and system, an aircraft, a distribution robot, a dispatching platform, and a handover method.

### BACKGROUND

Due to remote locations, scattered orders, and difficult distribution, rural logistics basically relies on human staff to complete rural order distribution, which has low distribution efficiency and high distribution costs.

In related art, cargoes are transported from a warehouse to a manned township distribution station and delivered to their addresses one by one by distribution staff, or the buyers pick up the cargoes at the township distribution station by themselves.

### SUMMARY

According to one aspect of the present disclosure, there is provided a cargo handover method, comprising: obtaining, by an aircraft, a distribution robot identifier; sending, by an aircraft, a hatch cover open request to a dispatching platform, wherein the hatch cover open request includes the distribution robot identifier, so that the dispatching platform sends a hatch cover open instruction to a distribution robot corresponding to the distribution robot identifier, to enable the distribution robot to open a hatch cover; delivering, by an aircraft, cargoes to the distribution robot upon a detection that the hatch cover is opened by the distribution robot.

In some embodiments of the present disclosure, the method further comprises: after the hatch cover is opened by the distribution robot, detecting by the distribution robot whether the cargoes are delivered into a storage cabin; if it is detected by the distribution robot that the cargoes are delivered into the storage cabin, closing the hatch cover and completing the handover of the cargoes.

In some embodiments of the present disclosure, the method further comprises: receiving, by an aircraft, a hatch cover detection instruction which is sent, in response to the hatch cover open request, by the dispatching platform; and in response to the hatch cover detection instruction, detecting, by an aircraft, whether the hatch cover of the distribution robot is opened.

In some embodiments of the present disclosure, obtaining a distribution robot identifier comprises: after reaching a cargo handover location, scanning, by an aircraft, a distribution robot parked at the cargo handover location to obtain the distribution robot identifier thereof.

According to another aspect of the present disclosure, a logistics method is provided, comprising: transporting, by an aircraft, cargoes from a distribution station to a cargo handover location of an aircraft and a distribution robot according to a fixed route; and delivering, by an aircraft, the cargoes to the distribution robot by the cargo handover method according to any one of the above embodiments, to enable the distribution robot to distribute the cargoes to a distribution address.

In some embodiments of the present disclosure, the method further comprises: after delivering the cargoes to the distribution robot, returning, by an aircraft, to the distribution station along the fixed route to prepare for a next task.

In some embodiments of the present disclosure, the method further comprises: receiving, by an aircraft, the fixed route sent by a dispatching platform.

In some embodiments of the present disclosure, the method further comprises: after delivering the cargoes to the distribution robot, returning, by an aircraft, to the distribution station along the fixed route to prepare for a next task.

According to another aspect of the present disclosure, an aircraft is provided, comprising a navigation module, configured to transport cargoes from a distribution station to a cargo handover location of the aircraft and a distribution robot according to a fixed route; and a delivery module, configured to deliver the cargoes to the distribution robot, to enable the distribution robot to distribute the cargoes to a distribution address.

In some embodiments of the present disclosure, the aircraft further comprises: a fixed route receiving module, configured to receive a fixed route sent by a dispatching platform.

In some embodiments of the present disclosure, the navigation module is further configured to enable the aircraft to return to the distribution station along the fixed route to prepare for a next task after the delivery module delivers the cargoes to the distribution robot.

In some embodiments of the present disclosure, the delivery module comprises: a distribution robot identifier obtaining unit, configured to obtain a distribution robot identifier; a hatch cover open request sending unit configured to send a hatch cover open request including the distribution robot identifier to the dispatching platform, to enable the dispatching platform to instruct a distribution robot corresponding to the distribution robot identifier to open a hatch cover; a hatch cover detection unit configured to detect whether the hatch cover of the distribution robot is opened; and a delivery unit configured to deliver cargoes to the distribution robot after the hatch cover detection unit detects that the hatch cover of the distribution robot is opened.

In some embodiments of the present disclosure, the delivery module further comprises: a hatch cover detection instruction receiving unit, configured to receive a hatch cover detection instruction which is sent, in response to the hatch cover open request, by the dispatching platform; and a hatch cover detection unit, configured to detect whether the hatch cover of the distribution robot is opened in the case that the hatch cover detection instruction receiving unit receives the hatch cover detection instruction.

In some embodiments of the present disclosure, the distribution robot identifier obtaining unit is configured to obtain a distribution robot identifier of a distribution robot parked at a cargo handover location by scanning after the aircraft reaches the cargo handover location.

According to another aspect of the present disclosure, an aircraft is provided, comprising a memory configured to store computer instructions; and a processor configured to execute the instructions, so that the aircraft executes the cargo handover method or the logistics method according to any one of the foregoing embodiments.

According to another aspect of the present disclosure, a distribution robot is provided, comprising: a cargo receiving module, configured to receive cargoes delivered by an aircraft at a cargo handover location of an aircraft and the distribution robot; and a cargo distribution module, configured to distribute the cargoes to a distribution address.

In some embodiments of the present disclosure, the cargo distribution module comprises: a navigation information receiving unit, configured to receive navigation path information sent by a dispatching platform, wherein the dispatching platform generates the navigation path information according to distribution address information; and an automatic driving unit, configured to automatically drive to a distribution address according to the navigation path information to complete the distribution of the cargoes.

In some embodiments of the present disclosure, the automatic driving unit is further configured to return the distribution robot to the location cargo handover location of the aircraft and the distribution robot after distributing the cargoes to the distribution address, and wait for a next task.

In some embodiments of the present disclosure, the cargo receiving module comprises: a hatch cover open instruction receiving unit, configured to receive a hatch cover open instruction which is sent by a dispatching platform in response to a hatch cover open request including a distribution robot identifier received from the aircraft, wherein the distribution robot identifier is obtained after the aircraft reaches a location of the aircraft and the distribution robot; and a hatch cover open unit, configured to open a hatch cover in response to the hatch cover open instruction received by the hatch cover open instruction receiving unit so as to receive the cargoes delivered by the aircraft.

In some embodiments of the present disclosure, the cargo receiving module further comprises: a cargo detection unit, configured to detect whether the cargoes are delivered into a storage cabin after the hatch cover open unit opens the hatch cover; and a hatch cover closing unit, configured to close the hatch cover after the cargo detection unit detects that the cargoes are delivered into the storage cabin to complete the handover of the cargoes.

According to another aspect of the present disclosure, a dispatching platform is provided, comprising: a fixed route transmitting module, configured to transmit a fixed route to an aircraft, to enable the aircraft to reach a cargo handover location of the aircraft and a distribution robot from a distribution station according to the fixed route; a navigation information generating module, configured to generate navigation path information according to distribution address information after the distribution robot receives the cargoes delivered by the aircraft; and a navigation information transmitting module, configured to transmit the navigation path information to the distribution robot, to enable the distribution robot to automatically drive to the distribution address according to the navigation path information to complete the delivery of the cargoes.

In some embodiments of the present disclosure, the dispatching platform further comprises: a cargo handover control module, configured to control the aircraft to deliver the cargoes to the distribution robot to complete the handover of the cargoes.

In some embodiments of the present disclosure, the cargo handover control module comprises: a hatch cover open request receiving unit, configured to receive a hatch cover open request sent by the aircraft, wherein the hatch cover open request includes a distribution robot identifier obtained from a distribution robot by the aircraft; a hatch cover open instruction sending unit, configured to send a hatch cover open instruction to a distribution robot corresponding to the distribution robot identifier in the case that the hatch cover open request receiving unit receives the hatch cover open request, so as to control the distribution robot to open a hatch cover; and a hatch cover detection instruction sending unit, configured to send a hatch cover detection instruction to the aircraft in the case that the hatch cover open request receiving unit receives the hatch cover open request, so that the aircraft detects whether the hatch cover of the distribution robot is opened, and delivers the cargoes to the distribution robot after detecting that the hatch cover of the distribution robot is opened.

According to another aspect of the present disclosure, there is provided a logistics system comprising an aircraft according to any one of the above embodiments, a distribution robot according to any one of the above embodiments, and a dispatching platform according to any one of the above embodiments.

According to a still another aspect of the present disclosure, a computer-readable storage medium is provided on which computer program instructions are stored, which when executed by a processor implement the cargo handover method or the logistics method according to any one of the above embodiments.

By accurately docking between an aircraft and a distribution robot, cargoes can be automatically transferred from the aircraft to the distribution robot. The present disclosure is a distribution solution taking advantage of the linkage between an aircraft and a distribution robot. The disclosure can effectively solve the outstanding problem existing in rural logistics and distribution. As a result, this disclosure can bring the same rapid logistics experience to rural areas as urban online shopping, and can realize intelligent rural logistics.

### BRIEF DESCRIPTION OF THE DRAWINGS

In order to more clearly explain the embodiments of the present disclosure or the technical solutions in the prior art, a brief introduction will be given below for the drawings required to be used in the description of the embodiments or the prior art. It is obvious that, the drawings illustrated as follows are merely some of the embodiments of the present disclosure. For a person skilled in the art, he or she may also acquire other drawings according to such drawings on the premise that no inventive effort is involved.

FIG. 1 is a schematic diagram of a logistics system according to some embodiments of the present disclosure;

FIG. 2 is a schematic diagram of a logistics method according to a first embodiment of the present disclosure;

FIG. 3 is a schematic diagram of a cargo handover method according to the first embodiment of the present disclosure;

FIG. 4 is a schematic diagram of a cargo handover method according to a second embodiment of the present disclosure;

FIG. 5 is a schematic diagram of an aircraft according to some embodiments of the present disclosure;

FIG. 6 is a schematic diagram of a delivery module in some embodiments;

FIG. 7 is a schematic diagram of a distribution robot according to some embodiments of the present disclosure;

FIG. 8 is a schematic diagram of a cargo distribution module in some embodiments;

FIG. 9 is a schematic diagram of a cargo receiving module in some embodiments;

FIG. 10 is a schematic diagram of a dispatching platform according to some embodiments of the present disclosure;

FIG. 11 is a schematic diagram of a cargo handover control module in some embodiments.

### DETAILED DESCRIPTION

Below, a clear and complete description will be given for the technical solution of embodiments of the present disclosure with reference to the figures of the embodiments. Obviously, merely some embodiments of the present disclosure, rather than all embodiments thereof, are given herein. The following description of at least one exemplary embodiment is in fact merely illustrative and is in no way intended as a limitation to the invention, its application or use. All other embodiments obtained by persons of ordinary skill in the art based on the embodiments of the present disclosure without creative efforts shall fall within the protection scope of the present disclosure.

Unless otherwise specified, the relative arrangement, numerical expressions and numerical values of the components and steps set forth in these examples do not limit the scope of the invention.

At the same time, it should be understood that, for ease of description, the dimensions of the various parts shown in the drawings are not drawn to actual proportions.

Techniques, methods, and apparatus known to those of ordinary skill in the relevant art may not be discussed in detail, but where appropriate, these techniques, methods, and apparatuses should be considered as part of the specification.

Of all the examples shown and discussed herein, any specific value should be construed as merely illustrative and not as a limitation. Thus, other examples of exemplary embodiments may have different values.

Notice that, similar reference numerals and letters are denoted by the like in the accompanying drawings, and therefore, once an item is defined in a drawing, there is no need for further discussion in the accompanying drawings.

The inventors have realized that: in the related art, rural logistics distribution is basically completed by human staff. Due to the remote locations and poor infrastructure, the current rural logistics has a long distribution time and high distribution cost; due to the influence of geographical environments, some villages in remote areas do not yet support home delivery, and buyers need to pickup cargoes at township distribution stations by themselves, which reduces the user experience and willingness to purchase online, resulting in huge online shopping potential that cannot be unleashed.

In view of the above technical problems, the present disclosure provides a logistics method and system, an aircraft, a distribution robot, a dispatching platform, and a handover method, and realizes intelligent rural logistics taking advantage of the linkage between an aircraft and a distribution robot.

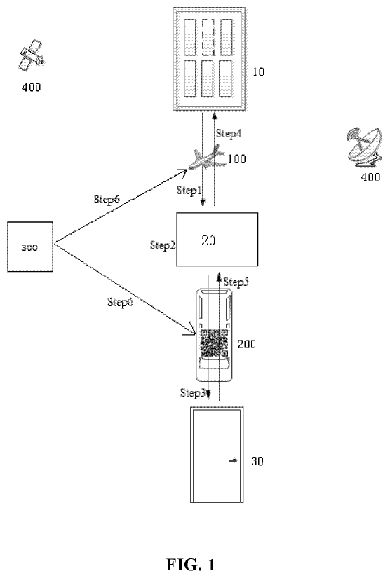

FIG. 1 is a schematic diagram of a logistics system according to some embodiments of the present disclosure. As shown in FIG. 1, the logistics system may comprise an aircraft 100, a distribution robot 200, and a dispatching platform 300, wherein, the intelligent rural logistics of the present disclosure is based on the linkage between the aircraft 100 and the distribution robot 200, with a township distribution station 10 as a hub.

The dispatching platform 300 is used to transmit a fixed route to the aircraft 100 in advance.

In some embodiments of the present disclosure, the selection of the fixed route must first meet the national aircraft management regulations. When planning a route, it is necessary to avoid some large transmission lines in advance, and to plan a route with a relatively complete signal coverage.

The aircraft 100 is used to start cargo transportation and delivery along the route after receiving the route. The aircraft 100 is used to reach a cargo handover location 20 of the aircraft 100 and the distribution robot 200 from a distribution station 10 (for example, a township distribution station) according to a fixed route. The aircraft 100 is used for the operation of the fixed route. The starting point of the fixed route is the township distribution station, and the end point is the cargo handover location 20 of the aircraft 100 and the distribution robot 200, that is, a location of the distribution robot parked at a village.

In some embodiments of the present disclosure, the aircraft 100 may be implemented as an unmanned aerial vehicle.

In some embodiments of the present disclosure, the specific location of the distribution robot may be a flat open area such as a flat village road surface or a village center cultural square, which is convenient for the aircraft to accurately position the distribution robot.

In some embodiments of the present disclosure, the delivery radius of the aircraft 100 is approximately 15 km-20 km.

The aircraft 100 is further used to deliver cargoes to the distribution robot 200 after it reaches the cargo handover location 20.

The distribution robot 200 is used to deliver the cargoes from the cargo handover location 20 to a distribution address 30, that is, to a user's home to complete the distribution of the cargoes.

In some embodiments of the present disclosure, the distribution robot 200 may be implemented as an unmanned vehicle.

In some embodiments of the present disclosure, as shown in FIG. 1, the logistics system may further comprise a positioning device 400, wherein, the positioning device 400 is used to realize positioning of the aircraft 100 and the distribution robot 200, facilitating the dispatching platform 300 to monitor the status of the aircraft 100 and the distribution robot 200 in real time, and to provide navigation path planning services for the aircraft 100 and the distribution robot 200.

Based on the logistics system provided by the above embodiments of the present disclosure, in order to solve the problem of scattered orders and difficult delivery in rural areas in the related art, the present invention uses a distribution solution taking advantage of the linkage between an aircraft and a distribution robot to replace the existing delivery-staff based distribution mode. Therefore, the above-mentioned embodiments of the present disclosure can greatly shorten the distribution time and save logistics costs. With the scaling-up of the solution of the above embodiment of the present disclosure, the logistics and distribution system can be deeply extended to rural areas. Therefore, the above embodiments of the present disclosure truly solve the problem of final delivery of rural e-commerce, so that rural users in the future can fully experience the convenience and benefits brought by e-commerce.

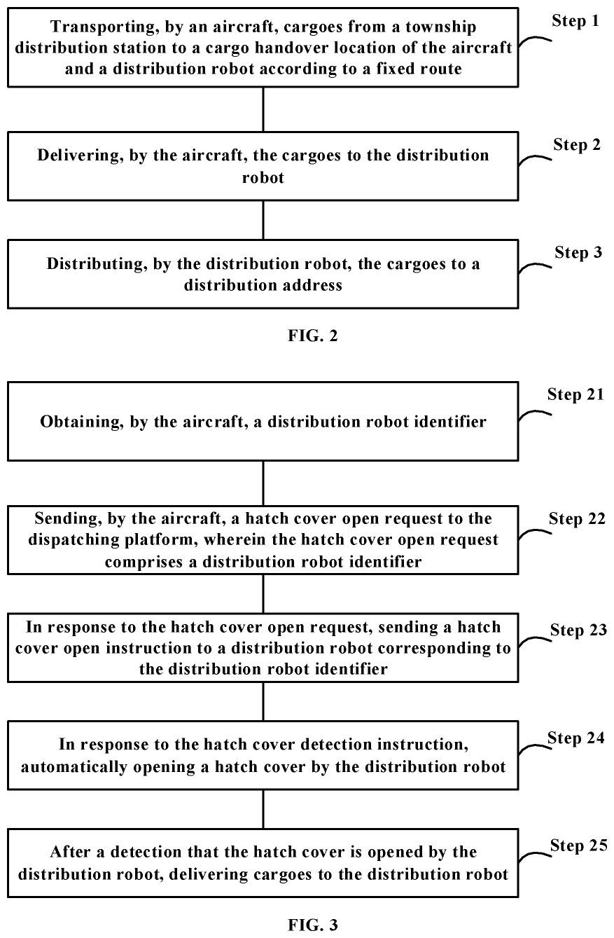

FIG. 2 is a schematic diagram of a logistics method according to a first embodiment of the present disclosure. Preferably, this embodiment can be executed by the disclosed logistics system. As shown in FIG. 2, the method may comprise step 1 to step 3.

Step 1: transporting, by an aircraft 100, cargoes from a township distribution station 10 to a cargo handover location of the aircraft 100 and a distribution robot 200 according to a fixed route.

In some embodiments of the present disclosure, before step 1, the method may further comprise: transmitting, by a dispatching platform. 300, a fixed route to the aircraft 100, so that the aircraft 100 can reach the cargo handover location of the aircraft 100 and the distribution robot 200.

Step 2: delivering, by the aircraft 100, the cargoes to the distribution robot 200.

Step 3: distributing, by the distribution robot 200, the cargoes to a distribution address.

In some embodiments of the present disclosure, the method may further comprise: generating, by the dispatching platform 300, navigation path information according to distribution address information after the distribution robot 200 receives the cargoes delivered by the aircraft 100; transmitting, by the dispatching platform 300, the navigation path information to the distribution robot 200, so that the distribution robot 200 can automatically drive to the distribution address according to the navigation path information, and complete the distribution of the target cargoes after the cargoes are received by a user.

Based on the logistics method provided in the above embodiment of the present disclosure, through accurately docking between an aircraft and a distribution robot, cargoes can be automatically transferred from the aircraft to the distribution robot. The above embodiment of the present disclosure is a distribution solution taking advantage of the linkage between an aircraft and a distribution robot. The above embodiment of the present disclosure can effectively solve the outstanding problem existing in rural logistics and distribution. As a result, the above embodiment of the present disclosure can bring the same rapid logistics experience to rural areas as urban online shopping, and can realize intelligent rural logistics.

FIG. 1 further shows a schematic diagram of a logistics method according to a second embodiment of the present disclosure. Preferably, this embodiment can be executed by a logistics system of the present disclosure. Compared with the embodiment in FIG. 2, the logistics method in the embodiment in FIG. 1 may further comprise step 4.

Step 4: after delivering the cargoes to the distribution robot 200, the aircraft 100 returns to the distribution station along the fixed route to prepare for a next task.

In some embodiments of the present disclosure, as shown in FIG. 1, the method may further comprise step 5.

Step 5: the distribution robot 200 returns to the cargo handover location 20 of the aircraft 100 and the distribution robot 200 after distributing the cargoes to the distribution address, and waits for a next task.

In some embodiments of the present disclosure, as shown in FIG. 1, the method may further comprise step 6.

Step 6: the dispatching platform 300 monitors the status of the aircraft 100 and the distribution robot 200 in real time.

In order to solve the problem of scattered orders and difficult delivery in rural areas in the related art, the above embodiment of the present disclosure adopts a distribution solution taking advantage of the linkage between an aircraft and a distribution robot to replace the existing delivery-staff based distribution mode. Therefore, the above-mentioned embodiment of the present disclosure can greatly shorten the distribution time and save logistics costs. With the scaling-up of the solution of the above embodiment of the present disclosure, the logistics and distribution system can be deeply extended to rural areas. Therefore, the above embodiments of the present disclosure truly solve the problem of final delivery of rural e-commerce, so that rural users in the future can fully experience the convenience and benefits brought by e-commerce.

FIG. 3 is a schematic diagram of a cargo handover method according to the first embodiment of the present disclosure. Preferably, this embodiment can be executed by a logistics system of the present disclosure. As shown in FIG. 3, the method of handing over cargoes between an aircraft and a distribution robot (that is, step 2 in the embodiment of FIG. 1 or FIG. 2) may comprise step 21 to step 25.

Step 21: obtaining, by the aircraft 100, a distribution robot identifier.

In some embodiments of the present disclosure, the step 21 may comprise: after reaching a cargo handover location, scanning, by the aircraft 100, a distribution robot 200 parked at the cargo handover location to obtain the distribution robot identifier thereof.

In some embodiments of the present disclosure, a unique two-dimensional code electronic identifier is provided on the top of each distribution robot. Therefore, when the aircraft flies over the top of the distribution robot, the distribution robot identifier of the distribution robot 200 can be obtained by scanning.

Step 22: sending, by the aircraft 100, a hatch cover open request to the dispatching platform 300, wherein the hatch cover open request includes a distribution robot identifier.

Step 23: in response to the hatch cover open request, sending, by the dispatching platform 300, a hatch cover open instruction to a distribution robot 200 corresponding to the distribution robot identifier.

Step 24: in response to the hatch cover detection instruction, automatically opening a hatch cover by the distribution robot 200.

Step 25: upon a detection that the hatch cover is opened by the distribution robot 200, delivering cargoes to the distribution robot 200 by the dispatching platform 300.

In some embodiments of the present disclosure, after step 24, the method may further comprise: after the hatch cover is opened by the distribution robot 200, detecting, by the distribution robot 200, whether the cargoes are delivered into a storage cabin; if it is detected by the distribution robot 200 that the cargoes are delivered into the storage cabin, closing the hatch cover and completing the handover of the cargoes. After the handover of the cargoes, the aircraft returns to the township distribution station along the fixed route to prepare for a next task. The distribution robot starts logistics distribution.

In some embodiments of the present disclosure, after step 22, the method may further comprise: in response to the hatch cover open request, sending, by the dispatching platform 300, a hatch cover detection instruction to the aircraft 100; in response to the hatch cover detection instruction, detecting, by the aircraft 100, whether the hatch cover of the distribution robot 200 is opened.

Based on the method of cargo handover between an aircraft and a distribution robot provided in the above embodiment of the present disclosure, when the aircraft reaches the cargo handover location (the location where the distribution robot is located) according to the navigation line, accurate target locking can be achieved. Therefore, in the above embodiment of the present disclosure, through accurately docking between an aircraft and a distribution robot, cargoes can be automatically transferred from the aircraft to the distribution robot. The above embodiment of the present disclosure is a distribution solution taking advantage of the linkage between an aircraft and a distribution robot. The above embodiment of the present disclosure can effectively solve the outstanding problem existing in rural logistics and distribution. As a result, the above embodiment of the present disclosure can bring the same rapid logistics experience to rural areas as urban online shopping, and can realize intelligent rural logistics.

In some embodiments of the present disclosure, each aircraft 100 and each distribution robot 200 have a built-in SIM card, which can directly communicate with the dispatching platform 300. The communication between the aircraft 100 and the dispatching platform 300 may be implemented through a public wireless communication network such as 4G LTE. The communication between the distribution robot 200 and the dispatching platform 300 can be realized through a public wireless communication network such as 4G LTE.

In some embodiments of the present disclosure, the wireless communication between the aircraft 100 and the distribution robot 200 may use a wireless communication protocol such as a WIFI communication protocol, an infrared communication protocol, a Bluetooth communication protocol, and an NFC (Near Field Communication) protocol for the wireless communication.

Compared with the WIFI communication protocol, adopting the NFC communication protocol in the present disclosure has the advantages of more convenient opening of the hatch cover, better application prospects, and long-term development. But the popularity of NFC terminals is not enough.

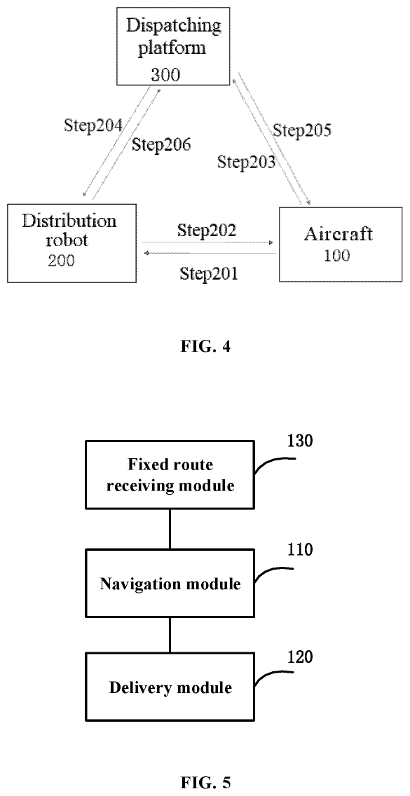

FIG. 4 is a schematic diagram of a cargo handover method according to a second embodiment of the present disclosure. Preferably, this embodiment can be executed by a logistics system of the present disclosure. As shown in FIG. 3, the cargo handover method (that is, step 2 in the embodiment of FIG. 1 or FIG. 2) may comprise step 201 to step 206.

Step 201 and step 202: scanning, by the aircraft 100, the top of the distribution robot 200 to obtain a distribution robot identifier (i.e., distribution robot information ID) of the distribution robot 200.

step 203: sending, by the aircraft 100, a hatch cover open request to the dispatching platform 300, wherein the hatch cover open request includes the distribution robot identifier.

step 204: in response to the hatch cover open request, sending, by the dispatching platform 300, a hatch cover open instruction to the distribution robot 200 corresponding to the distribution robot identifier.

step 205: in response to the hatch cover open request, sending, by the dispatching platform 300, a hatch cover detection instruction to the aircraft 100, so that the aircraft 100 detects whether the hatch cover of the distribution robot 200 is opened, and delivers the cargoes to the distribution robot 200 after detecting that the hatch cover of the distribution robot 200 is opened.

step 206: reporting, by the distribution robot 200, hatch cover status information, distribution robot status, and positioning information to the dispatching platform 300.

In order to solve the problem of scattered orders and difficult delivery in rural areas in the related art, the above embodiment of the present disclosure adopts a distribution solution taking advantage of the linkage between an aircraft and a distribution robot to replace the existing delivery-staff based distribution mode. Therefore, the above-mentioned embodiment of the present disclosure can greatly shorten the distribution time and save logistics costs. With the scaling-up of the solution of the above embodiment of the present disclosure, the logistics and distribution system can be deeply extended to rural areas. Therefore, the above embodiments of the present disclosure truly solve the problem of final delivery of rural e-commerce, so that rural users in the future can fully experience the convenience and benefits brought by e-commerce.

The specific structures and functions of the aircraft, the distribution robot, and the dispatching platform in the above embodiments of the present disclosure will be further described in specific embodiments below.

FIG. 5 is a schematic diagram of an aircraft according to some embodiments of the present disclosure. As shown in FIG. 5, the aircraft 100 in the embodiment of FIG. 1 or FIG. 4 comprises a navigation module 110 and a delivery module 120.

The navigation module 110 is used to navigate the aircraft 100 along a fixed route to a cargo handover location of the aircraft 100 and a distribution robot 200.

In some embodiments of the present disclosure, the navigation module 110 is further used to enable the aircraft 100 to return to the distribution station along the fixed route to prepare for a next task after the delivery module 120 delivers the cargoes to the distribution robot 200.

The delivery module 120 is used to deliver the cargoes to the distribution robot 200, to enable the distribution robot 200 to distribute the cargoes to a distribution address.

In some embodiments of the present disclosure, as shown in FIG. 5, the aircraft 100 may further comprise a fixed route receiving module 130, wherein, the fixed route receiving module 130 is used to receive a fixed route sent by the dispatching platform 300.

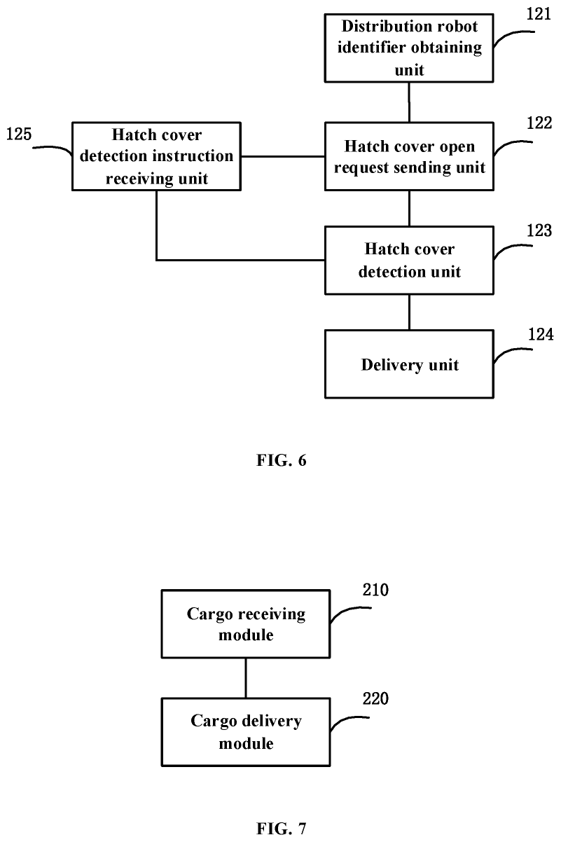

FIG. 6 is a schematic diagram of a delivery module in some embodiments. As shown in FIG. 6, the delivery module 120 in the embodiment of FIG. 5 may comprise a distribution robot identifier obtaining unit 121, a hatch cover open request sending unit 122, a hatch cover detection unit 123, and a delivery unit 124.

The distribution robot identifier obtaining unit 121 is used to obtain a distribution robot identifier.

In some embodiments of the present disclosure, the distribution robot identifier obtaining unit 121 may be used to obtain a distribution robot identifier of the distribution robot 200 parked at the cargo handover location by scanning after the aircraft 100 reaches the cargo handover location.

The hatch cover open request sending unit 122 is used to send a hatch cover open request to the dispatching platform 300, wherein the hatch cover open request includes the distribution robot identifier, the dispatching platform 300 instructing the distribution robot 200 corresponding to the distribution robot identifier to open a hatch cover in response to the hatch cover open request.

The hatch cover detection unit 123 is used to detect whether the hatch cover of the distribution robot 200 is opened.

The delivery unit 124 is used to deliver cargoes to the distribution robot 200 after the hatch cover detection unit 123 detects that the hatch cover of the distribution robot 200 is opened.

In some embodiments of the present disclosure, as shown in FIG. 6, the delivery module 120 may further comprise a hatch cover detection instruction receiving unit 125, wherein, the hatch cover detection instruction receiving unit 125 is used to receive a hatch cover detection instruction sent by the dispatching platform 300, wherein the dispatching platform 300 sends a hatch cover detection instruction to an aircraft 100 in response to the hatch cover open request.

The hatch cover detection unit 123 is used to detect whether the hatch cover of the distribution robot 200 is opened when the hatch cover detection instruction receiving unit receives the hatch cover detection instruction.

According to another aspect of the present disclosure, an aircraft is provided, comprising a memory configured to store computer instructions; and a processor configured to execute the instructions, so that the aircraft executes implements the cargo handover method or the logistics method according to any one of the foregoing embodiments.

Based on the aircraft provided in the above embodiment of the present disclosure, through accurately docking between an aircraft and a distribution robot, cargoes can be automatically transferred from the aircraft to the distribution robot. The above embodiment of the present disclosure is a distribution solution taking advantage of the linkage between an aircraft and a distribution robot. The above embodiment of the present disclosure can effectively solve the outstanding problem existing in rural logistics and distribution. As a result, the above embodiment of the present disclosure can bring the same rapid logistics experience to rural areas as urban online shopping, and can realize intelligent rural logistics.

FIG. 7 is a schematic diagram of a distribution robot according to some embodiments of the present disclosure. As shown in FIG. 7, the distribution robot 200 in the embodiment of FIG. 1 or FIG. 4 may comprise a cargo receiving module 210 and a cargo delivery module 220.

The cargo receiving module 210 is used to receive cargoes delivered by an aircraft 100 at a cargo handover location of the aircraft 100 and the distribution robot 200.

The cargo distribution module 220 is used to distribute the cargoes to a distribution address.

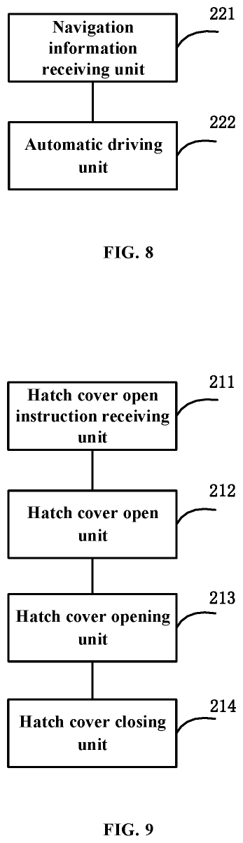

FIG. 8 is a schematic diagram of a cargo distribution module in some embodiments; As shown in FIG. 8, the cargo delivery module 220 in the embodiment of FIG. 7 may comprise a navigation information receiving unit 221 and an automatic driving unit 222.

The navigation information receiving unit 221 is used to receive navigation path information sent by a dispatching platform 300, wherein the dispatching platform 300 generates the navigation path information according to distribution address information.

The automatic driving unit 222 is used to automatically drive to a distribution address according to the navigation path information to complete the distribution of the cargoes.

In some embodiments of the present disclosure, the automatic driving unit 222 is further used to return the distribution robot 200 to the cargo handover location of the aircraft 100 and the distribution robot 200 after distributing the cargoes to the distribution address, and wait for a next task.

FIG. 9 is a schematic diagram of a cargo receiving module in some embodiments. As shown in FIG. 9, the cargo receiving module 210 in the embodiment of FIG. 7 may comprise a hatch cover open instruction receiving unit 211 and a hatch cover open unit 212.

The hatch cover open instruction receiving unit 211 is used to receive a hatch cover open instruction sent by a dispatching platform 300, wherein the aircraft 100 obtains a distribution robot identifier after reaching a cargo handover location of the aircraft 100 and the distribution robot 200, and sends a hatch cover open request to the dispatching platform 300, the hatch cover open request including the distribution robot identifier, to enable the dispatching platform 300 to send a hatch cover open instruction to a distribution robot 200 corresponding to the distribution robot identifier.

The hatch cover open unit 212 is used to open a hatch cover in response to the hatch cover open instruction received by the hatch cover open instruction receiving unit 211 so as to receive the cargoes delivered by the aircraft 100, wherein the aircraft 100 delivers the cargoes to the distribution robot 200 after detecting that the hatch cover is opened by the distribution robot 200.

In some embodiments of the present disclosure, as shown in FIG. 9, the cargo receiving module 210 may further comprise a cargo detection unit 213 and a hatch cover closing unit 214.

The cargo detection unit 213 is used to detect whether the cargoes are delivered into a storage cabin after the hatch cover open unit 212 opens the hatch cover.

The hatch cover closing unit 214 is used to close the hatch cover after the cargo detection unit 213 detects that the cargoes are delivered into the storage cabin to complete the handover of the cargoes.

Based on the distribution robot provided by the above embodiments of the present disclosure, in order to solve the problem of scattered orders and difficult delivery in rural areas in the related art, the present invention uses a distribution solution taking advantage of the linkage between an aircraft and a distribution robot to replace the existing delivery-staff based distribution mode. Therefore, the above-mentioned embodiments of the present disclosure can greatly shorten the distribution time and save logistics costs. With the scaling-up of the solution of the above embodiment of the present disclosure, the logistics and distribution system can be deeply extended to rural areas. Therefore, the above embodiments of the present disclosure truly solve the problem of final delivery of rural e-commerce, so that rural users in the future can fully experience the convenience and benefits brought by e-commerce.

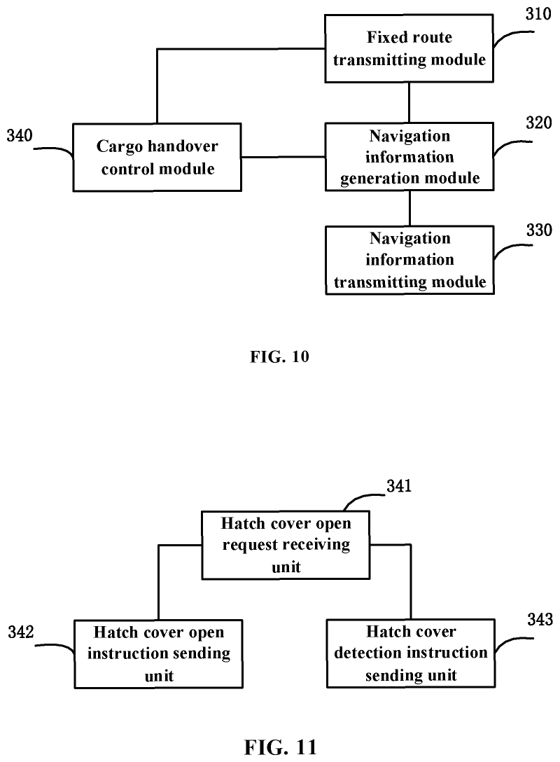

FIG. 10 is a schematic diagram of a dispatching platform according to some embodiments of the present disclosure. As shown in FIG. 10, the dispatching platform 300 in the embodiment of FIG. 1 or FIG. 4 may comprise a fixed route transmitting module 310, a navigation information generation module 320, and a navigation information transmitting module 330.

The fixed route transmitting module 310 is used to transmit a fixed route to an aircraft 100, to enable the aircraft 100 to reach a cargo handover location of the aircraft 100 and a distribution robot 200 according to the fixed route.

The navigation information generating module 320 is used to generate navigation path information according to distribution address information after the distribution robot 200 receives the cargoes delivered by the aircraft 100.

The navigation information transmitting module 330 is used to transmit the navigation path information to the distribution robot 200, to enable the distribution robot 200 to automatically drive to the distribution address according to the navigation path information to complete the delivery of the cargoes.

In some embodiments of the present disclosure, as shown in FIG. 10, the dispatching platform 300 may further comprise a cargo handover control module 340, wherein, the cargo handover control module 340 is used to control the aircraft 100 to deliver the cargoes to the distribution robot 200 to complete the handover of the cargoes.

FIG. 11 is a schematic diagram of a cargo handover control module in some embodiments. As shown in FIG. 11, the cargo handover control module 340 in the embodiment of FIG. 10 may comprise a hatch cover open request receiving unit 341, a hatch cover open instruction sending unit 342, and a hatch cover detection instruction sending unit 343.

The hatch cover open request receiving unit 341 is used to receive a hatch cover open request sent by the aircraft 100, wherein the hatch cover open request includes a distribution robot identifier obtained from the distribution robot 200 after the aircraft reaches a cargo handover location of the aircraft 100 and the distribution robot 200.

The hatch cover open instruction sending unit 342 is used to send a hatch cover open instruction to a distribution robot 200 corresponding to the distribution robot identifier in the case that the hatch cover open request receiving unit 341 receives the hatch cover open request, so as to control the distribution robot 200 to open a hatch cover.

The hatch cover detection instruction sending unit 343 is used to send a hatch cover detection instruction to the aircraft 100 in the case that the hatch cover open request receiving unit 341 receives the hatch cover open request, so that the aircraft 100 detects whether the hatch cover of the distribution robot 200 is opened, and delivers the cargoes to the distribution robot 200 after detecting that the hatch cover of the distribution robot 200 is opened.

Based on the dispatching platform provided by the above embodiments of the present disclosure, in order to solve the problem of scattered orders and difficult delivery in rural areas in the related art, the present invention uses a distribution solution taking advantage of the linkage between an aircraft and a distribution robot to replace the existing delivery-staff based distribution mode. Therefore, the above-mentioned embodiments of the present disclosure can greatly shorten the distribution time and save logistics costs. With the scaling-up of the solution of the above embodiment of the present disclosure, the logistics and distribution system can be deeply extended to rural areas. Therefore, the above embodiments of the present disclosure truly solve the problem of final delivery of rural e-commerce, so that rural users in the future can fully experience the convenience and benefits brought by e-commerce.

According to a still another aspect of the present disclosure, a computer-readable storage medium is provided on which computer program instructions are stored, which when executed by a processor implement the cargo handover method or the logistics method according to any one of the above embodiments. For example, the computer readable storage medium is a non-transitory computer readable storage medium.

Functional units such as the dispatching platform 300, the distribution robot identifier obtaining unit 121, the hatch cover open request sending unit 122, the hatch cover detection unit 123, and the cargo receiving module 210 described above may be implemented as a general-purpose processor for performing the functions described in this application, Programmable logic controller (PLC), digital signal processor (DSP), application specific integrated circuit (ASIC), field programmable gate array (FPGA) or other programmable logic devices, discrete gates or transistor logic devices, discrete hardware components or any appropriate combination thereof.

Heretofore, the present disclosure has been described in detail. In order to avoid obscuring the concepts of the present disclosure, some details known in the art are not described. Based on the above description, those skilled in the art can understand how to implement the technical solutions disclosed herein.

A person skilled in the art can understand that all or part of the steps for carrying out the method in the above embodiments can be completed by hardware or a program instructing the related hardware, wherein the program can be stored in a computer readable storage medium. The storage medium may be a read-only memory (ROM), a magnetic disk or a compact disk (CD).

The above description of this invention is given for illustration and description, but is not exhaustive and is not intended to limit the present invention to the form disclosed herein. Various modifications and variations are apparent for a person of ordinary skill in the art. Embodiments are selected and described for a better illustration of the principle and practical application of the present disclosure, so that those skilled in the art can understand the present disclosure and envisage various embodiments with various modifications suited to specific usages.

1: A cargo handover method, comprising:
obtaining, by an aircraft, a distribution robot identifier;
sending, by an aircraft, a hatch cover open request to a dispatching platform, wherein the hatch cover open request includes the distribution robot identifier, so that the dispatching platform sends a hatch cover open instruction to a distribution robot corresponding to the distribution robot identifier, to enable the distribution robot to open a hatch cover; and
upon a detection that the hatch cover is opened by the distribution robot, delivering, by an aircraft, cargoes to the distribution robot.

2: The cargo handover method according to claim 1, further comprising:
receiving, by an aircraft, a hatch cover detection instruction which is sent, in response to the hatch cover open request, by the dispatching platform; and
in response to the hatch cover detection instruction, detecting, by an aircraft, whether the hatch cover of the distribution robot is opened.

3: The cargo handover method according to claim 1, wherein obtaining a distribution robot identifier comprises:
after reaching a cargo handover location, scanning, by an aircraft, a distribution robot parked at the cargo handover location to obtain the distribution robot identifier thereof.

4: A logistics method, comprising:
transporting, by an aircraft, cargoes from a distribution station to a cargo handover location of an aircraft and a distribution robot according to a fixed route; and
delivering, by an aircraft, the cargoes to the distribution robot using the cargo handover method according to claim 1.

5: The logistics method according to claim 4, further comprising:
after delivering the cargoes to the distribution robot, returning, by an aircraft, to the distribution station along the fixed route.

6: The logistics method according to claim 4, further comprising:
receiving, by an aircraft, the fixed route sent by a dispatching platform.

7-13. (canceled)

14: An aircraft comprising:
a memory, configured to store computer instructions; and
a processor, configured to execute the instructions, so that the aircraft executes the logistics method according to claim 4

15: A distribution robot, comprising:
a cargo receiving module, configured to receive cargoes delivered by an aircraft at a cargo handover location of an aircraft and the distribution robot; and
a cargo distribution module, configured to distribute the cargoes to a distribution address, comprising:
a hatch cover open instruction receiving unit, configured to receive a hatch cover open instruction which is sent by a dispatching platform in response to a hatch cover open request including a distribution robot identifier received from the aircraft, wherein the distribution robot identifier is obtained after the aircraft reaches a location of the aircraft and the distribution robot; and
a hatch cover open unit, configured to open a hatch cover in response to the hatch cover open instruction received by the hatch cover open instruction receiving unit so as to receive the cargoes delivered by the aircraft.

16: The distribution robot according to claim 15, wherein the cargo distribution module comprises:
a navigation information receiving unit, configured to receive navigation path information sent by a dispatching platform, wherein the dispatching platform generates the navigation path information according to distribution address information; and
an automatic driving unit, configured to automatically drive to the distribution address according to the navigation path information.

17: The distribution robot according to claim 16, wherein,
the automatic driving unit is further configured to return the distribution robot to the cargo handover location of the aircraft and the distribution robot after distributing the cargoes to the distribution address.

18. (canceled)

19: The distribution robot according to claim 15, wherein the cargo receiving module further comprises:
a cargo detection unit, configured to detect whether the cargoes are delivered into a storage cabin after the hatch cover open unit opens the hatch cover; and
a hatch cover closing unit, configured to close the hatch cover after the cargo detection unit detects that the cargoes are delivered into the storage cabin.

20: A dispatching platform, comprising:
a fixed route transmitting module, configured to transmit a fixed route to an aircraft, to enable the aircraft to reach a cargo handover location of the aircraft and a distribution robot from a distribution station according to the fixed route;
a navigation information generating module, configured to generate navigation path information according to distribution address information after the distribution robot receives the cargoes delivered by the aircraft a navigation information transmitting module, configured to transmit the navigation path information to the distribution robot, to enable the distribution robot to automatically drive to the distribution address according to the navigation path information; and
a cargo handover control module, configured to control the aircraft to deliver the cargoes to the distribution robot, comprising:
a hatch cover open request receiving unit, configured to receive a hatch cover open request sent by the aircraft, wherein the hatch cover open request includes a distribution robot identifier obtained from a distribution robot by the aircraft;
a hatch cover open instruction sending unit, configured to send a hatch cover open instruction to a distribution robot corresponding to the distribution robot identifier in the case that the hatch cover open request receiving unit receives the hatch cover open request, so as to control the distribution robot to open a hatch cover; and
a hatch cover detection instruction sending unit, configured to send a hatch cover detection instruction to the aircraft in the case that the hatch cover open request receiving unit receives the hatch cover open request, so that the aircraft detects whether the hatch cover of the distribution robot is opened, and delivers the cargoes to the distribution robot after detecting that the hatch cover of the distribution robot is opened.

21-22. (canceled)

23: A logistics system comprising:
an aircraft having a memory, configured to store computer instructions, and a processor, configured to execute the instructions, so that the aircraft executes a logistics method that includes obtaining, by the aircraft, a distribution robot identifier, sending, by the aircraft, a hatch cover open request to a dispatching platform, wherein the hatch cover open request includes the distribution robot identifier, so that the dispatching platform sends a hatch cover open instruction to a distribution robot corresponding to the distribution robot identifier, to enable the distribution robot to open a hatch cover, and upon a detection that the hatch cover is opened by the distribution robot, delivering, by an aircraft, cargoes to the distribution robot;
a distribution robot that includes a cargo receiving module, configured to receive cargoes delivered by an aircraft at a cargo handover location of an aircraft and the distribution robot, and a cargo distribution module, configured to distribute the cargoes to a distribution address, the distribution robot comprising: a hatch cover open instruction receiving unit, configured to receive a hatch cover open instruction which is sent by a dispatching platform in response to a hatch cover open request including a distribution robot identifier received from the aircraft, wherein the distribution robot identifier is obtained after the aircraft reaches a location of the aircraft and the distribution robot; and a hatch cover open unit, configured to open a hatch cover in response to the hatch cover open instruction received by the hatch cover open instruction receiving unit so as to receive the cargoes delivered by the aircraft; and
a dispatching platform that includes a fixed route transmitting module, configured to transmit a fixed route to an aircraft, to enable the aircraft to reach a cargo handover location of the aircraft and a distribution robot from a distribution station according to the fixed route, a navigation information generating module, configured to generate navigation path information according to distribution address information after the distribution robot receives the cargoes delivered by the aircraft, a navigation information transmitting module, configured to transmit the navigation path information to the distribution robot, to enable the distribution robot to automatically drive to the distribution address according to the navigation path information, and a cargo handover control module, configured to control the aircraft to deliver the cargoes to the distribution robot, comprising:
a hatch cover open request receiving unit, configured to receive a hatch cover open request sent by the aircraft, wherein the hatch cover open request includes a distribution robot identifier obtained from a distribution robot by the aircraft;
a hatch cover open instruction sending unit, configured to send a hatch cover open instruction to a distribution robot corresponding to the distribution robot identifier in the case that the hatch cover open request receiving unit receives the hatch cover open request, so as to control the distribution robot to open a hatch cover; and
a hatch cover detection instruction sending unit, configured to send a hatch cover detection instruction to the aircraft in the case that the hatch cover open request receiving unit receives the hatch cover open request, so that the aircraft detects whether the hatch cover of the distribution robot is opened, and delivers the cargoes to the distribution robot after detecting that the hatch cover of the distribution robot is opened.

24: A computer-readable storage medium on which computer program instructions are stored, which when executed by a processor implement the cargo handover method according to claim 1.

25: A computer-readable storage medium on which computer program instructions are stored, which when executed by a processor implement the logistics method according to claim 4.

26: The aircraft according to claim 14, wherein the logistics method further comprises:
after delivering the cargoes to the distribution robot, returning, by the aircraft, to the distribution station along the fixed route.

27: The aircraft according to claim 14, wherein the logistics method further comprises:
receiving, by the aircraft, the fixed route sent by a dispatching platform.

28: An aircraft comprising:
a memory, configured to store computer instructions; and
a processor, configured to execute the instructions, so that the aircraft executes the cargo handover method according to claim 1.

29: The aircraft according to claim 28, wherein the cargo handover method further comprises:
receiving, by the aircraft, a hatch cover detection instruction which is sent, in response to the hatch cover open request, by the dispatching platform; and
in response to the hatch cover detection instruction, detecting, by the aircraft, whether the hatch cover of the distribution robot is opened.

30: The aircraft according to claim 28, wherein the cargo handover method further comprises:
after reaching a cargo handover location, scanning, by the aircraft, a distribution robot parked at the cargo handover location to obtain the distribution robot identifier thereof.
